(19) United States
(12) Patent Application Publication
(10) Pub. No.: US 2007/0074749 A1
(43) Pub. Date: Apr. 5, 2007

(54) Padding for crutches

(76) Inventors: Kathleen Marie Jones, Schoolcraft, MI (US); Laura Kmet, Paw Paw, MI (US)

Correspondence Address: FLYNN THIEL BOUTELL & TANIS, P.C., 2026 RAMBLING ROAD, KALAMAZOO, MI, 49008-1631, US

(21) Appl. No.: 11/243,950

(22) Filed: Oct. 5, 2005

(51) Int. Cl. A61H 3/02

(52) U.S. Cl. 135/73; 150/154

(57) ABSTRACT

A system for padding a crutch to prevent chafing. An armpit padding device covers the conventional armpit engaging portion of a crutch with a combined three layers of nylon fabric, foam pad, and fleece fabric. A handle padding device covers the conventional grab handle portion of a crutch with a combined three layers of nylon fabric, foam pad, and fleece fabric. Chafing is prevented by a combined effect of fleece fabric elasticity and the elasticity of a foam pad that is held in place by being sandwiched between nylon and fleece.

### FIELD OF THE INVENTION

The present invention pertains to crutches, and more particularly, to pads for the armpit rests and hand grips of crutches to prevent chafing on the user's armpits and hands.

### BACKGROUND OF THE INVENTION

A conventional crutch 10 (refer to FIG. 1) has foam padding 2, 6 placed over wood or metal frame pieces 4, 8 where the crutch 10 makes contact with the user's armpit and hand, respectively. The crutch's armpit engaging element 4 is covered with an armpit foam pad 2 and its grab handle 8 is covered with a handle foam pad 6. The foam padding 2, 6, while better than nothing, has been found to have disadvantages when a crutch (or crutches) is used for an extended period of time. Chafing is a common complaint, even when the foam pads remain in good condition.

Chafing is typically caused by the combination of perspiration and friction. The underarms and hands of a person using a crutch are vulnerable to chafing because these are the body parts that make frictional contact (directly or indirectly through clothing) with the crutch and because perspiration on the hands and underarms is a natural result of the exertion of ambulating using one or more crutches. Although the foam padding of a conventional crutch enhances comfort by spreading the contact forces across a broader area, it does little to prevent chafing.

An alternative conventional way of providing padding for a crutch is to fit a leather covered pneumatic bladder on the armpit frame piece. This innovation may be an improvement over simple foam padding in terms of redistributing pressure against the user's skin, but it is relatively expensive and adds the complication of requiring an inflation process and inflation equipment.

Other conventional devices for padding crutches use padding covered with fabric. One problem with the conventional pads is that the placement of the padding is not efficient to provide protection from chafing. Another problem with the conventional pads is that the fabric type used is not appropriate to prevent chafing. Specifically, the use of flocked materials is not effective to prevent chafing because it is not effective in providing isolation from friction. Examples of flocked materials are velvet or artificial furs, which are formed by a base plus glued fibers. Flocked materials consistently transfer underlying motion as indirect friction to a user's skin. This occurs primarily because the gaps between the glued on fibers permit the user's skin to make contact with the substrate. Due to these ineffective designs, chafing has not been effectively prevented.

Examples of the conventional arrangements summarized above can be found in patents U.S. Pat. No. 1,499,458, U.S. Pat. No. 4,711,261, U.S. Pat. No. 5,078,640, U.S. Pat. No. 5,101,846 and U.S. Pat. No. 6,718,994.

### SUMMARY OF THE INVENTION

Preventing chafing is accomplished by reducing the exposure of the user's skin to friction. One mechanism of reducing friction is the use of fleece fabric. Another mechanism of reducing friction is the combination of fleece fabric layered over foam layered over nylon fabric. These mechanisms combine to isolate the skin of the user from friction.

One aspect of the present invention is an armpit padding device for a crutch that fits over the conventional armpit foam pad. The armpit padding device has a lining layer of nylon fabric, an outer layer of fleece fabric, and an interior layer of foam padding between the lining layer and the outer layer. The interior layer of foam padding is arranged so as to rest over the top and both sides of the conventional armpit foam pad.

Another aspect of the present invention is a handgrip padding device for a crutch that fits over the conventional handgrip foam pad. The handgrip padding device has a lining layer of nylon fabric, an outer layer of fleece fabric, and an interior layer of foam padding between the two fabric layers. The handgrip padding device wraps entirely around the handgrip foam pad and secures in place with corresponding strips of hook and loop fastener strips at each end.

A further aspect of the present invention is a method of manufacturing the armpit padding devices. The nylon fabric lining layer, the foam padding interior layer and the fleece fabric outer layer are cut to shape and laid over one another in order. The lining layer and the outer layer are sewn together along their elongate edges and at a distance spaced inward from the elongate edges. The lining layer and the outer layer are also sewn together along their shorter edges. The three layers are together folded upward along a central longitudinal axis and the shorter edges are then sewn together. An elastic band is sewn along the elongate edges in a stretched state so that the elongate edges are gathered together by the elastic band upon its release after sewing is complete.

Additional features and advantages according to the present invention will be evident upon review of the following description and study of the accompanying drawings.

### BRIEF DESCRIPTION OF THE DRAWINGS

FIG. 1 shows an exploded fragmentary perspective view of a conventional crutch.

FIG. 2 shows an exploded fragmentary perspective view of padding devices according to an embodiment of the present invention in relation to a conventional crutch shown in phantom.

FIG. 3 shows a cross sectional view of an armpit padding device according to an embodiment of the present invention in relation to a conventional crutch shown in phantom.

FIG. 4 shows a cross sectional view of a handgrip padding device according to an embodiment of the present invention in relation to a conventional crutch shown in phantom.

FIG. 5 shows an exploded elevational view of the armpit padding device prior to assembly.

FIG. 6 shows plan view of the armpit padding device at an intermediate assembly stage.

FIG. 7 shows an exploded elevational view of a handgrip padding device according to an embodiment of the present invention prior to assembly.

FIG. 8 shows plan view of a handgrip padding device according to the present invention at an intermediate assembly stage.

FIG. 9 shows cross sectional view of an assembled handgrip padding device according to the present invention.

FIG. 10 shows an end on elevational view of the armpit padding device according to the present invention being assembled.

### DETAILED DESCRIPTION

The present invention prevents chafing caused by use of a crutch or pair or crutches. Chafing is prevented by reducing the exposure of the user's skin to friction. As mentioned above in the summary of the invention, two mechanisms are utilized together to provide this result. One mechanism of reducing friction is the use of fleece fabric. Another mechanism of reducing friction is the combination of fleece fabric layered over foam layered over nylon fabric.

Fleece tends to isolate skin from friction because it provides some resiliency (or “give”) between the skin and the fabric's movement, yet it does not provide transfer of the underlying motion as indirect friction. That is because fleece is a complete product, in contrast with flocked materials (e.g., velvet or artificial furs, which are formed by a base plus glued fibers) which consistently provide transfer of underlying motion as indirect friction.

The layering of fleece fabric over foam layered over nylon fabric provides a combined affect that isolates the user from friction. The nylon fabric has a non-slip interface with the foam padding of a conventional crutch. This resistance to slippage prevents transfer of indirect friction. Additionally, transfer of indirect friction is suppressed by the fact that the interior layer of foam padding inside a padding device embodied according to the present invention is held tightly between the nylon fabric of the lining layer and the fleece fabric of the outer layer. Neither the lining layer nor the outer layer slips with respect to the foam sandwiched between them. The non-slip relationship between the nylon fabric and the underlying conventional foam pad of the crutch, combined with the non-slip relationship between the fleece fabric, the interior layer foam pad and the nylon fabric ensure that friction is not imparted to the skin of the user.

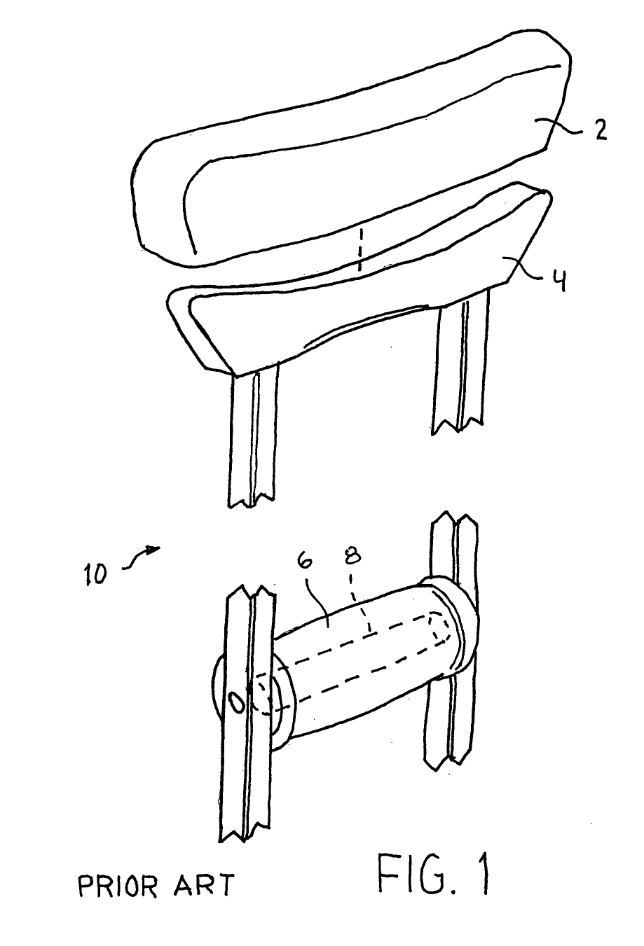

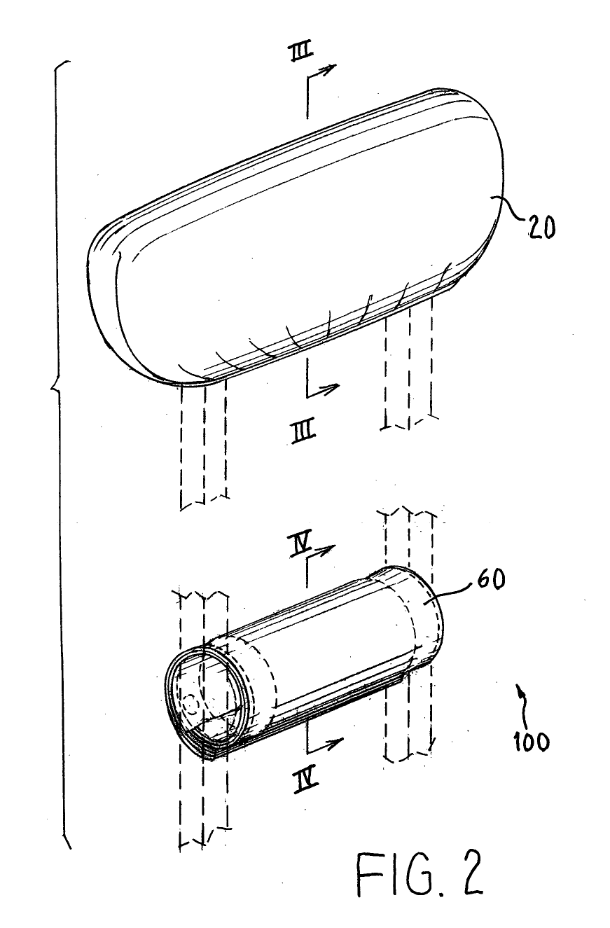

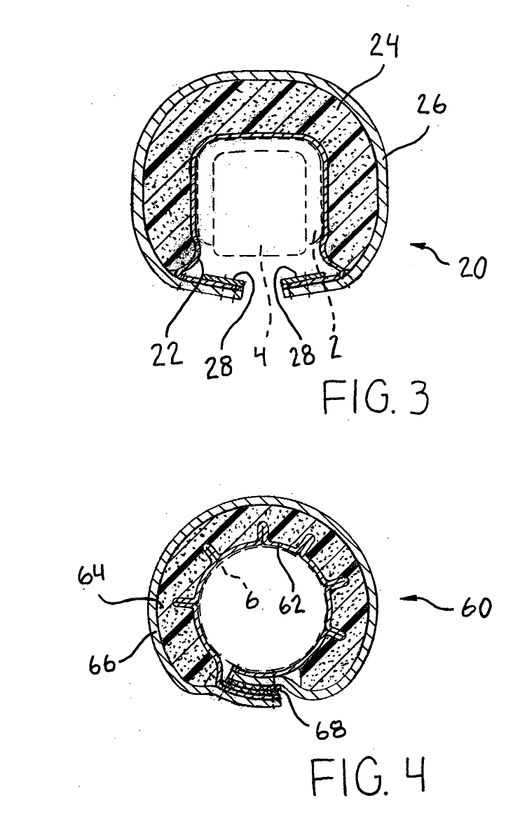

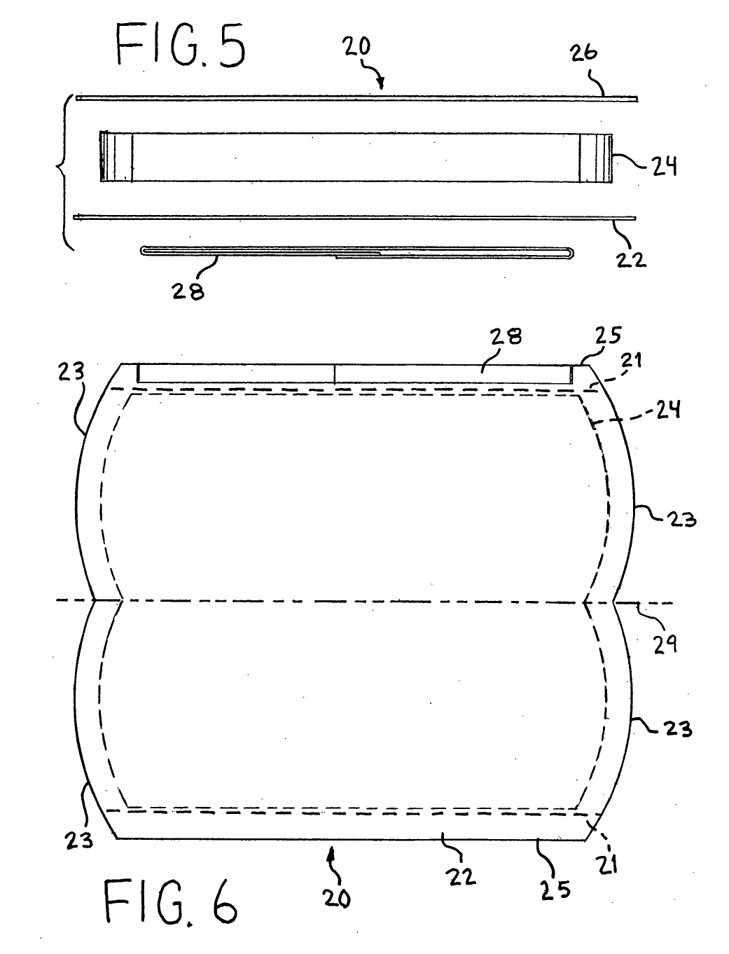

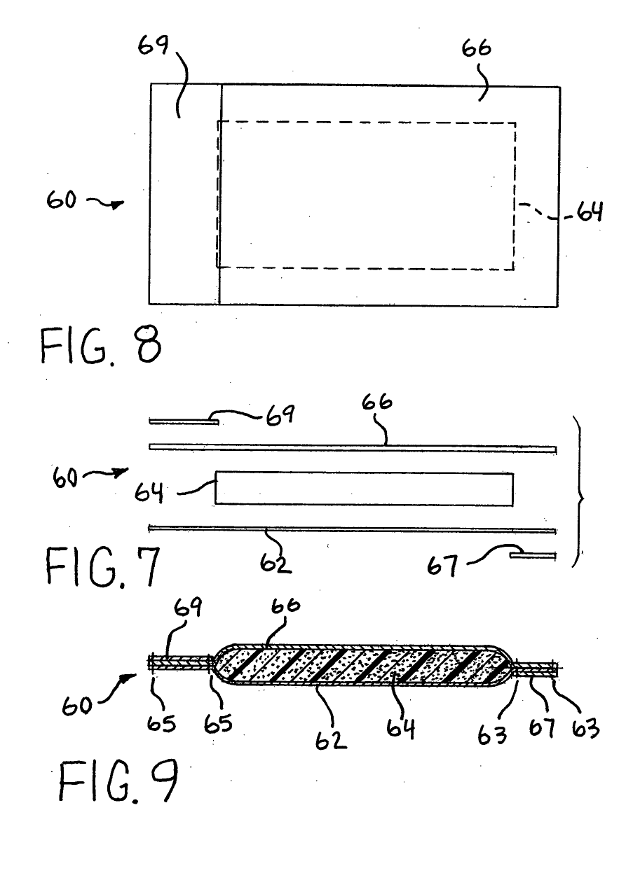

Referring to FIG. 2, a padding system 100 according to the present invention is illustrated. An armpit padding device 20 is fitted over the armpit engaging element 4 and the armpit foam pad 2 (see FIG. 1) of the crutch (shown in phantom). A handgrip padding device 60 is fitted over the grab handle 8 and its grab handle foam pad 6 (see FIG. 1). The bottom periphery of the armpit padding device 20 is bunched by an elastic band 28 (see FIG. 3) to resiliently grip the crutch 10.

Referring to FIG. 3, the armpit padding device 20 is shown in cross section in place over the armpit engaging element 4 and the armpit foam pad 2, which are shown in phantom. A lining layer 22 is shown wrapped around and in intimate contact with the armpit foam pad 2. An outer layer 26 wraps all the way around the crutch armpit structure and is gathered at the bottom by the elastic band 28. An interior layer 26 formed of foam padding is sandwiched tightly between the lining layer 22 and the outer layer 26. The interior layer 24 is disposed over the top of the foam pad 2 and extends downward along the sides of the foam pad 2. According to a preferred embodiment, the lining layer 22 is formed of nylon fabric and the outer layer 26 is formed of fleece fabric.

Referring to FIG. 4, the handgrip padding device 60 is shown in cross section in place around the handle foam pad 6 which is shown in phantom. A lining layer 62 is wrapped around to make intimate contact with the handle foam pad 6. An outer layer 66 wraps all the way around the outside to overlap for fastening by a hook and loop fastener 68. An interior layer 64 of foam padding is sandwiched tightly between the lining layer 62 and the outer layer 66. The interior layer 26 is provides resilient padding around about 75% of the handle foam pad 6, with the unpadded portion being preferably oriented downwardly. The hook and loop fastener 68 may be advantageously embodied, for example, using the product sold under the VELCRO® trademark.

Referring to FIG. 5, the separate unassembled parts of the armpit padding device 20 are shown in their relative positions prior to assembly. The lining layer 22, the outer layer 26 and the interior layer 24 are shown in stacked order with the lining layer 22 and the outer layer 26 having corresponding dimensions and the interior layer 24 being sized to be retained between the lining and outer layers when they are sewn together. The elastic band 28 is shown adjacent to the lining layer 22.

Referring to FIG. 6, relative positioning and shapes of the liner layer 22 and the interior layer 24 are shown as the armpit padding device 20 is being assembled. The liner layer 22 and the interior layer 24 are shown as both having shapes that evoke a laterally stretched hour glass and has elongated edges 25 and shorter curved edges 23. The shape of the interior layer 24 is slightly smaller than that of the liner layer 22 to provide an allowance for the stitching necessary to assemble the device. The outer layer 26 (obscured in this view by the liner layer; refer to FIG. 5) has the same shape as the liner layer 22.

Straight stitching 21 runs parallel to, and spaced inwardly from, the elongate edges 25 and fastens the outer layer 26 together with the liner layer 22 adjacent the elongate edges of the interior layer 24. The elastic band 28 is shown adjacent an elongate edge 25 of the lining layer 22, to which it is to be affixed.

Referring to FIG. 7, the separate unassembled parts of the handgrip padding device 60 are shown in their relative positions prior to assembly. The lining layer 62, the outer layer 66 and the interior layer 64 are shown in stacked order with the lining layer 62 and the outer layer 66 having corresponding dimensions and the interior layer 64 being sized to be retained between the lining and outer layers when they are sewn together. The loop portion 69 and the hook portion 67 of the hook and loop fastener are shown at opposite ends of the device and on opposed sides of the layers 62, 64, 66.

Referring to FIG. 8, relative positioning and shapes of the outer layer 66 and the interior layer 64 are shown as the handgrip padding device 60 is being assembled. The outer layer 66 and the interior layer 64 are shown as both having rectangular shapes. The interior layer 64 is sized slightly smaller than the outer layer 66 to provide an allowance for the stitching necessary to assemble the device. The liner layer 62 (obscured in this view by the outer layer; refer to FIG. 7) has the same shape as the outer layer 66. The loop portion 69 of the hook and loop fastener is shown positioned on the outer layer 66 where it is to be affixed.

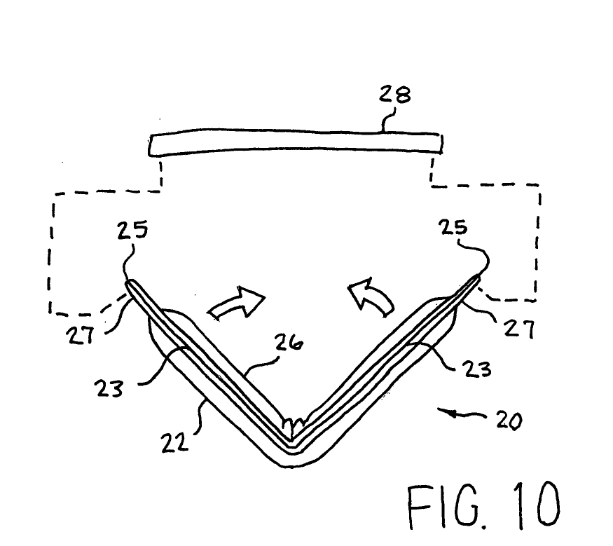

Referring to FIG. 9, the assembled handgrip padding device 60 is shown in cross section. The hook portion 67 of the hook and loop fastener is affixed by stitching 63 at a first end of the handgrip padding device 60 on the liner layer 62 side. The loop portion 69 of the hook and loop fastener is affixed by stitching 65 at the opposed end of the handgrip padding device 60 on the outer layer 66 side. The stitching 63, 65 at each end secure the interior layer 64 between the outer layer 66 and liner layer 62.

The hook portion 67 and the loop portion 69 are affixed to alternate sides of the opposed ends so that when the handle padding device 60 is wrapped around the handle foam pad 6 (refer to FIG. 4) the hook portion 67 and loop portion 69 are brought around into positions opposed to and facing one another. In this way the two corresponding portions of the hook and loop fastener 68 (refer to FIG. 4) are engaged to retain the handgrip padding device 60 wrapped around the grab handle foam pad 6.

The manner of assembling the armpit padding device is one of the aspects of the present invention. The parts are cut to shape as shown in FIG. 6 and described above, and are arranged for assembly as shown in both of FIGS. 5 and 6. As mentioned above, the outer layer 26 is fastened together with the liner layer 22 adjacent the elongate edges of the interior layer 24 using straight stitching 21 that runs parallel to and is spaced inwardly from the elongate edges 25. The outer layer 26 and the liner layer 22 are further fastened together along the curved edges 23, preferably using a zigzag stitch.

Referring to FIG. 10, the continued assembly process is further illustrated. The partially assembled armpit padding device 20 is folded along its central longitudinal axis 29 (refer to FIG. 6) so that the outer layer 26 is folded against itself in an inside-out fashion, as indicated by the motion arrows in FIG. 10, so that the two portions of the curved edges 23 meet. Then, at each end the two portions of the curved edges 23 are stitched together.

Once the curved edges 23 are stitched together, the elongate edges 25 form the free open end of the device. The elastic band 28 is stitched into the device in a stretched out state along the elongate edges 25 all the way around the free open end, on the area 27 of the inner layer between the elongate edges 25 and the straight stitching 21 (see FIG. 6) spaced from the elongate edges.

Once the elastic band 28 has been affixed, assembly is complete and the armpit padding device can then be reversed through its free open end (i.e., turned “right-side-out”) to be ready for use.

Although the present invention has been illustrated in terms of an exemplary embodiment, it would be understood by those of ordinary skill in the art that various changes and modifications may be made with respect to the illustrated embodiment without departing from the spirit and scope of the present invention.

What is claimed is:

1. A system for padding a crutch, the crutch having an armpit engaging element covered with an armpit foam pad and a grab handle covered with a handle foam pad, the system comprising:
an armpit padding device adapted to fit over the armpit engaging element and its armpit foam pad, the armpit padding device comprising a lining layer formed of nylon fabric, an outer layer formed of fleece fabric, and an interior layer formed of foam padding and disposed between the lining layer and the outer layer so as to rest over at least a top side of the conventional armpit foam pad; and
a handgrip padding device adapted to wrap around the grab handle and its grab handle foam pad, the handgrip padding device comprising a lining layer formed of nylon fabric, an outer layer formed of fleece fabric, an interior layer formed of foam padding and disposed between the handgrip padding devices two fabric layers, a hook portion of a hook and loop fastener affixed at a first end of the handgrip padding device, and a loop portion of the hook and loop fastener affixed at a second end of the handgrip padding device, the first and second ends being opposed to one another to configure the hook and loop fastener to retain the handgrip padding device wrapped around the grab handle when the hook portion and the loop portion are engaged.

2. The system of claim 1, wherein the lining layer of the armpit padding device, the interior layer of the armpit padding device, and the outer layer of the armpit padding device are all adapted to rest over the top side and over opposed sides of the conventional armpit foam pad.

3. The system of claim 1, the armpit padding device having a free open end sized to accommodate fitting of the armpit padding device over the and its armpit foam pad with the armpit foam pad in frictional engagement with the nylon fabric of the lining layer, the armpit padding device further comprising an elastic band affixed around the free open end to bring the free open end into resilient engagement with the crutch.

4. The system of claim 1, wherein fitting armpit padding device over the armpit engaging element and its armpit foam pad brings the nylon fabric liner layer into frictional engagement with the armpit foam pad, and wherein the armpit padding device is tightly constructed to prevent relative shifting of the interior layer with respect to either the lining layer or the outer layer, whereby texture provided by the fleece fabric of the outer layer and the relative engaged relationship of the outer layer to the armpit foam pad via the interior layer and the lining layer provide a combined effect that prevents chafing.

5. A method of manufacturing an armpit padding article, the method comprising:
cutting from nylon fabric a lining layer in an elongated hour-glass shape;
cutting from fleece fabric an outer layer in substantially the same elongated hour-glass shape as the lining layer;
cutting from a foam pad an interior layer in an elongate hour-glass shape about an inch smaller in dimension than that of the lining layer;
lying the lining layer, the interior layer and the outer layer together to overlap one another with the outer layer on top, the lining layer on the bottom, and the interior layer disposed therebetween;
sewing together the lining layer and the outer layer along their elongate edges;
sewing together the lining layer and the outer layer at a distance spaced inward from their elongate edges adjacent the elongate edges of the interior layer;
sewing together the lining layer and the outer layer along their shorter edges;
folding the lining layer, the interior layer and the outer layer upwardly together along a central longitudinal axis to bring to bring each of the shorter edges into a folded and self opposed configuration; and
sewing each of the shorter edges permanently affix them in the folded and self opposed configuration.

6. The method of manufacturing of claim 5, further comprising:
sewing an elastic band in a stretched state along the elongate edges so that the elongate edges are gathered together by the elastic band upon its release after sewing is complete.
